(19) United States
(12) Patent Application Publication
(10) Pub. No.: US 2023/0121085 A1
(43) Pub. Date: Apr. 20, 2023

(54) SOLID ELECTROLYTE FOR LITHIUM SECONDARY BATTERY, AND METHOD FOR MANUFACTURING THE SAME, AND LITHIUM SECONDARY BATTERY

(71) Applicants: Toyota Jidosha Kabushiki Kaisha, Toyota-shi (JP); Shanghai Jiao Tong University, Shanghai (CN)

(72) Inventors: Li YANG, Shanghai (CN); Zhengxi Zhang, Shanghai (CN); Zhu Liao, Shanghai (CN); Hideyuki Yamamura, Susono-shi (JP)

(73) Assignees: TOYOTA JIDOSHA KABUSHIKI KAISHA, Toyota-shi (JP); SHANGHAI JIAO TONG UNIVERSITY, Shanghai (CN)

(21) Appl. No.: 17/960,691

(22) Filed: Oct. 5, 2022

(30) Foreign Application Priority Data
Oct. 8, 2021 (CN) 202111172053.8

(51) Int. Cl. H01M 10/0565; H01M 10/052

(52) U.S. Cl. CPC H01M 10/0565; H01M 10/052; H01M 2300/0082; H01M 2300/0085

(57) ABSTRACT

The present disclosure relates to a solid electrolyte for a secondary battery which inhibits growth of lithium dendrite and is superior in cycle performance, a method for manufacturing the same, and a lithium secondary battery using the solid electrolyte. The solid electrolyte includes a polymer matrix, a lithium salt, a nitrile compound, and an additive ingredient, wherein the additive ingredient is at least one selected from a polymer or a copolymer polymerized from a monomer represented by the following Formula (1), and a polymer represented by the following Formula (2):

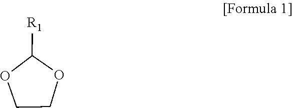

where R₁ is an olefin functional group having 2 to 6 carbon atoms;

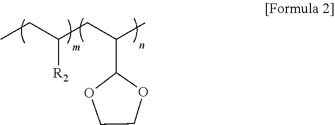

where R₂ is a functional group having an ionic liquid structure such as —COOCH₃, imidazole, pyrrole, piperidine, and a quaternary ammonium.

### BACKGROUND

### 1. Field

The present disclosure relates to a solid electrolyte for a lithium secondary battery, a method for manufacturing the same, and a lithium secondary battery.

### 2. Description of Related Art

Since the lithium metal has a high theoretical specific capacity (3860 mAh/g), a low negative potential (−3.04 V compared to a standard hydrogen electrode), a low metal mass (relative atomic mass M=6.94 g/mol, and density ρ=0.534 g/cm³), it is considered to be the ultimate anode. In addition, the lithium metal anode enables a sulfur/oxygen electrode having an energy density higher than the conventional lithium-containing negative electrode. However, uncontrollable growth of lithium dendrite and the low coulombic efficiency have led to a potential safety hazard and reduction of the cycle life, which have been obstacles to practical implementation of a lithium metal battery in the past several decades.

Extensive researches are being conducted on the electrode structure, the structure between solid electrolytes, optimization of an electrolyte, utilization of a solid electrolyte, and the like for stabilizing the lithium metal which repeats precipitation and detachment. Among them, the solid electrolyte attracts a lot of attention of the academic community and the industrial community, because not only it has a strong inhibitory effect on formation of lithium dendrite, it mitigates or eliminates the drawback in safety, namely inflammability, of the conventional nonaqueous liquid electrolyte, and further it promises a high energy density or a diaphragmless property.

1,3-Dioxolane (DOL) is a solvent often used for a liquid electrolyte of a lithium metal battery, and has the effect of mitigating formation of lithium dendrite. Thus far, a gel/solid polymer electrolyte (GPE/SPE) utilizing cationic polymerization of DOL (Non-Patent Literature 1, Non-Patent Literature 2) also has been known to be effective on inhibition of formation of lithium dendrite, but there is room for improvement.

### CITATION LIST

Non-Patent Literature 1: Qing Zhao, et al., “Solid-state polymer electrolytes with in-built fast interfacial transport for secondary lithium batteries”, Nature Energy, 2019, Vol. 4, p. 365-373

Non-Patent Literature 2: Feng-Quan Liu, et al. “Upgrading traditional liquid electrolyte via in situ gelation for future lithium metal batteries”, Science Advances, 2018, Vol. 4, eaat5383

### Patent Literature

Patent Literature 1: Chinese Laid-Open Patent Publication No. 108475808

### SUMMARY

An object of the present disclosure is to provide a solid electrolyte for a lithium secondary battery which inhibits growth of lithium dendrite and exhibits excellent cycle performance, a method for manufacturing the same, and a lithium secondary battery.

The present disclosure relates to a solid electrolyte for a lithium secondary battery. The solid electrolyte contains a polymer matrix, a lithium salt, a nitrile compound, and an additive ingredient. The additive ingredient is at least one selected from a polymer or a copolymer polymerized from a monomer represented by the following Formula (1), and a polymer represented by the following Formula (2):

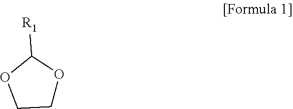

where R₁ is an olefin functional group having 2 to 6 carbon atoms;

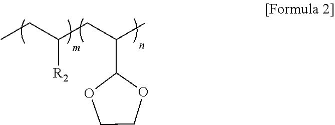

where R₂ is a functional group having an ionic liquid structure such as —COOCH₃, imidazole, pyrrole, piperidine, and a quaternary ammonium.

The solid electrolyte preferably contains 5 to 200 parts by mass of the lithium salt, 10 to 500 parts by mass of the nitrile compound, and 20 to 100 parts by mass of the additive ingredient with respect to 100 parts by mass of the polymer matrix.

When the additive ingredient is less than 20 parts by mass, the inhibitory effect of the solid electrolyte on formation of lithium dendrite is not remarkable, and the safety of the battery is reduced. When the additive ingredient exceeds 100 parts by mass, the mechanical strength of the solid electrolyte decreases.

The weight average molecular weight of the additive ingredient is preferably 1000 to 1000000 g/mol.

The additive ingredient is preferably poly(2-vinyl-1,3-dioxolane), or a copolymer of 2-vinyl-1,3-dioxolane and 1-vinyl-3-ethyl-bis(trifluoromethylsulfonyl)imidazole.

The present disclosure also includes a method for producing a solid electrolyte. The method includes: dissolving the polymer matrix, the lithium salt, the nitrile compound, and the additive ingredient in a solvent at a mass ratio of 100:5 to 200:10 to 500:20 to 100; stirring the resulting mixture at a temperature of 25 to 80° C. for 1 to 48 hours to prepare a solution; placing the resulting solution into a metal ware or a substrate; removing most of the solvent in an atmosphere of an inert gas to form an electrolyte membrane; vacuum-drying the electrolyte membrane at 25 to 100° C. for 2 to 48 hours; and placing the electrolyte membrane in a glove box filled with argon and drying the electrolyte membrane for 2 to 48 hours to remove the solvent and water, thereby obtaining the solid electrolyte.

The present disclosure also relates to a lithium secondary battery including the above solid electrolyte.

### Advantageous Effects of Disclosure

According to the present disclosure, it is possible to obtain a solid electrolyte which inhibits the growth of dendrite and brings superior cycle characteristics.

Other features and aspects will be apparent from the following detailed description, the drawings, and the claims.

### BRIEF DESCRIPTION OF THE DRAWINGS

FIG. 1 is a photograph of the polymer prepared in Example 1.

FIG. 2 is a ¹H NMR spectrum of VDOL in Example 1.

FIG. 3 is a ¹H NMR spectrum of PDOL in Example 1.

FIG. 4 is a GPC of PDOL in Example 1.

FIG. 5 is a TGA curve measured at a temperature rate of 10° C./min for the polymer in Example 1.

FIG. 6 is a DSC curve of PDOL in Example 1.

FIG. 7A is an optical photograph of SPE-1 in Example 1, and FIG. 7B is an optical photograph of the SPE-2.

FIG. 8 is DSC curves of the SPEs in Example 1.

FIG. 9 is a diagram showing the temperature dependency of the ionic conductivities in Example 1.

FIG. 10 is LSV curves of the SPEs in Example 1.

FIG. 11 shows charge-discharge curves of the Li/SPE-1/Li cell in Example 1 at 25° C.

FIG. 12 shows charge-discharge curves of the Li/SPE-2/Li cell in Example 1 at 25° C.

FIG. 13A shows voltage curves of the symmetric Li cells using SPEs in Example 1 at 0.2 mA/cm² at 25° C., and FIG. 13B shows voltage curves of the Li/SPE-2/Li cell at 25° C. at different current densities.

FIG. 14A is the cycle performance of the Li/LiFePO₄ cell using the solid electrolyte in Example 1 at 0.2 C and 25° C., FIG. 14B is the Li/LiFePO₄ cell using the SPE-1, and FIG. 14C is Li/LiFePO₄ cell using the SPE-2.

FIG. 15 shows charge-discharge curves of the Li/SPE-2/LiFePO₄ cell in Example 1 at 0.5 C.

FIG. 16 shows the cycle performance of the Li/SPE-2/LiFePO₄ cell in Example 1 at 0.5 C.

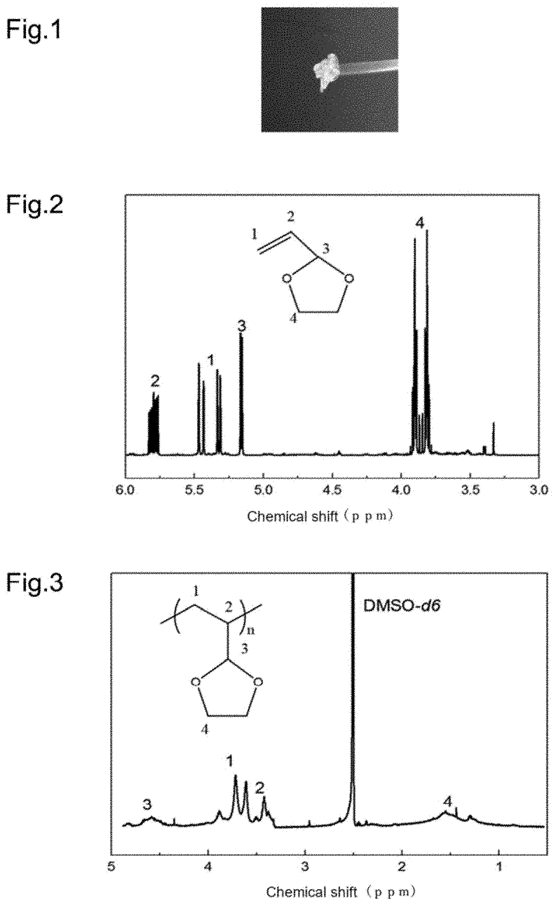

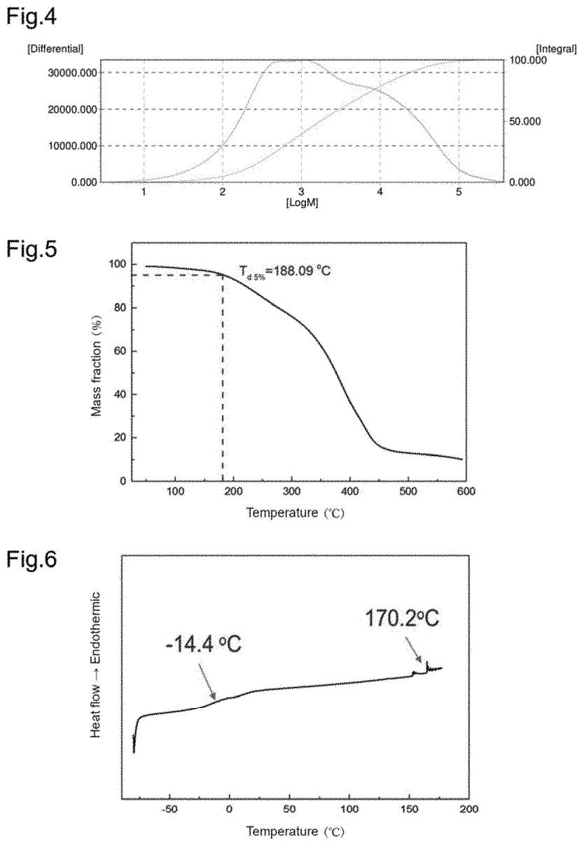

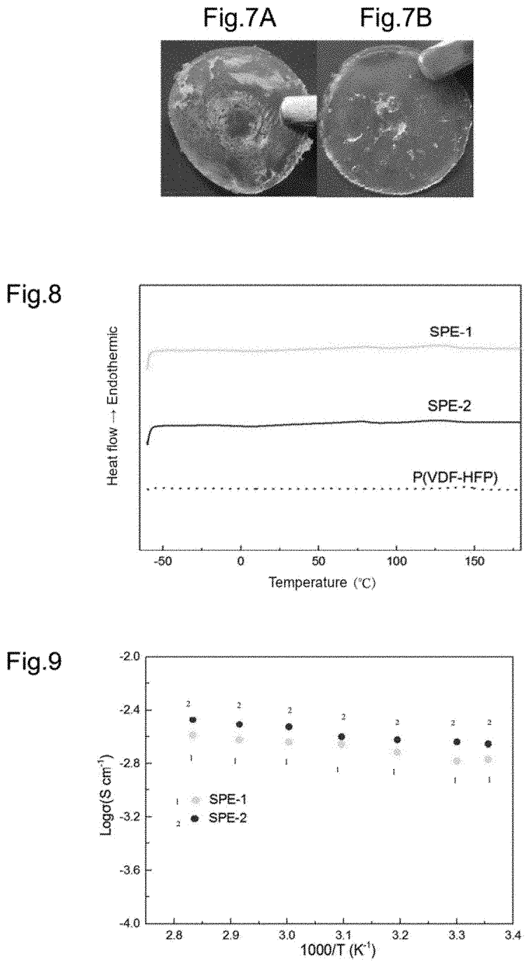

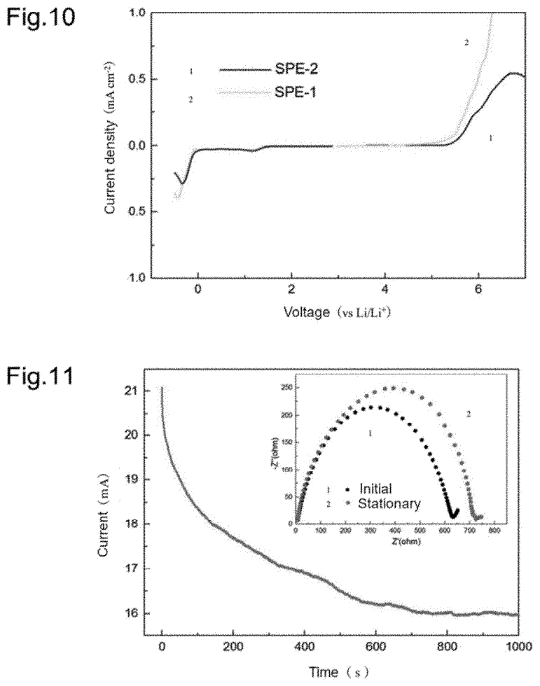

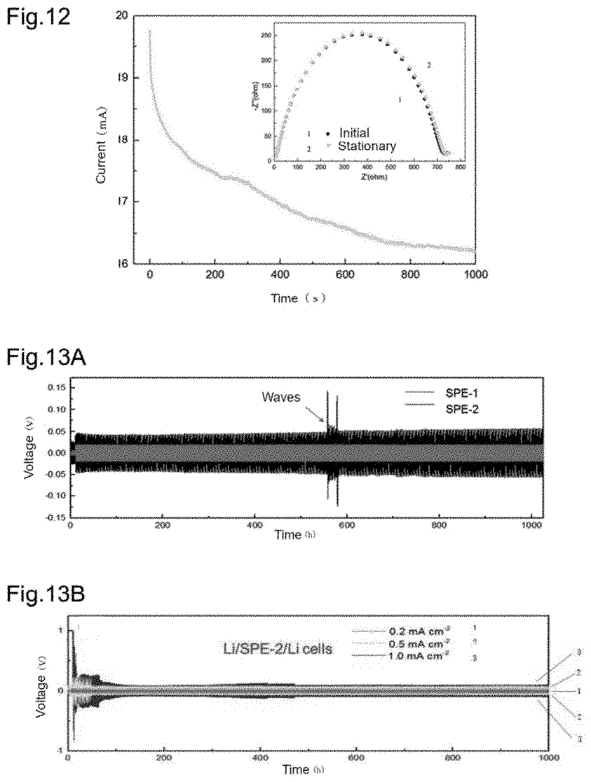

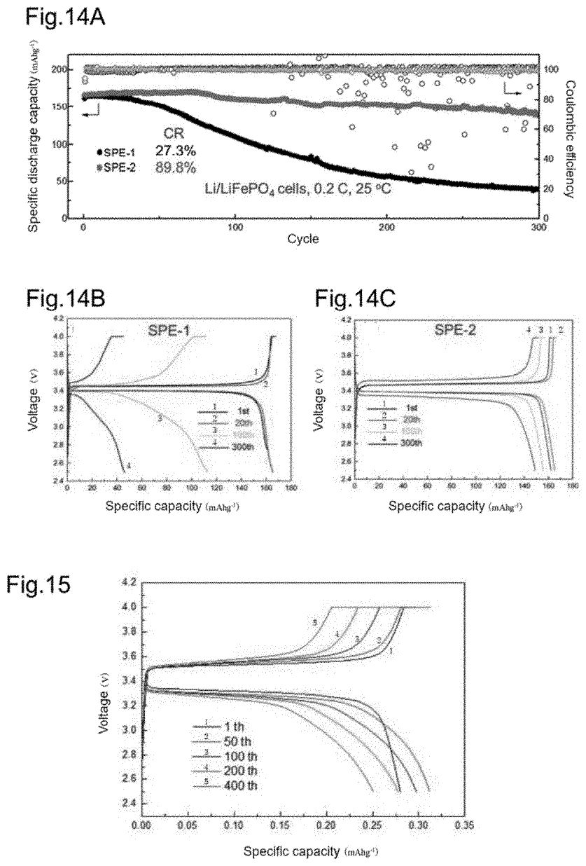

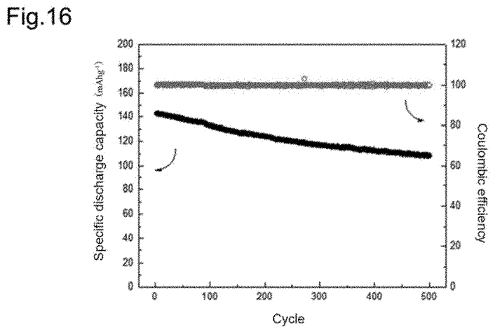

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

In the present application, an electrolyte and a cell were prepared and evaluated as follows.

### Preparation of PDOL

The method for preparing PDOL is not particularly limited, and any method conventionally known in the art may be used. In the present disclosure, PDOL was synthesized by simple anhydrous radical polymerization as shown in Formula 3. Specifically, 5.0 g of 2-vinyl-1,3-dioxolane was put into a three-neck flask under an argon atmosphere in an ice-water bath and stiffed for 10 min, and then 50.0 mg of 2,2′-azobis(isobutyronitrile) was rapidly added to the flask to initiate the polymerization reaction. Then, the solvent-free mixture was heated at 67° C. for 48 hours, the reaction mixture was dissolved in anhydrous CH₂Cl₂, and the resulting solution was added dropwise to anhydrous normal hexane. The precipitate was washed six times with anhydrous normal hexane, vacuum-dried overnight at 80° C., and then used.

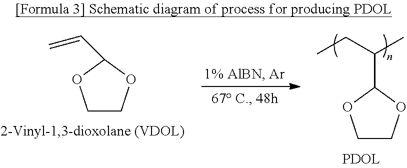

### Preparation of copolymer (P(DOL-IM₂TFSI)) of 2-vinyl-1,3-dioxolane and 1-vinyl-3-ethylbis(trifluoromethylsulfonyl)imidazole

In the present disclosure, as shown in Formula 4, the two monomers were first copolymerized at a predetermined mass ratio, which was then subjected to ethylation and ion exchange to yield P(DOL-IM₂TFSI). Specifically, 5.0 g of 2-vinyl-1,3-dioxolane, 5.6 g of 1-vinylimidazole, and 20 mL of ethanol were put into a three-neck flask under an argon atmosphere in an ice-water bath. After stirring for 30 min, 212 mg of 2,2′-azobisisobutyronitrile was rapidly added into the flask to initiate the polymerization reaction. Next, the mixture was heated at 80° C. for 48 hours. The resulting solution was washed three times with water and dried under vacuum at 80° C. for 24 hours. The resulting solid was dissolved in 50 mL of acetonitrile, to which 10.9 g of ethyl bromide was added, and the mixture was allowed to react at 50° C. for 24 hours. The acetonitrile was removed by rotary evaporation, and the product was washed three times with ethyl ether, and dried in a vacuum drying box at 80° C. for 24 hours. Then 5.0 g of the solid was added to 20 mL of deionized water, to this solution an aqueous LiTFSI prepared by dissolving 5.7 g of LiTFSI in deionized water was added dropwise, and the mixture was stirred at room temperature allowing to react for 2 hours. Then, the solid precipitate was filtered, washed with deionized water three times, and dried at 80° C. under vacuum for 24 hours to obtain the solid product of interest.

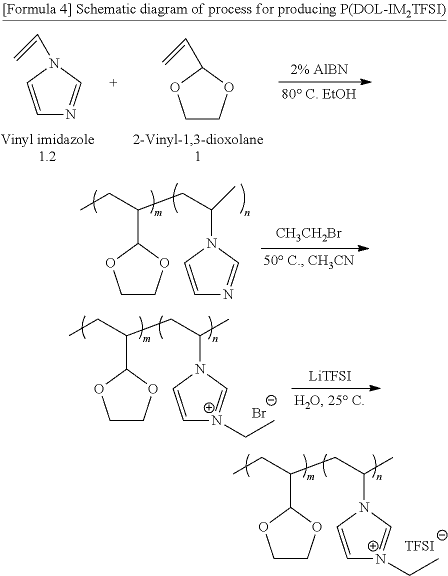

### Method for Preparing Solid Electrolyte

The polymer matrix, the lithium salt, the nitrile compound, and the additive ingredient were dissolved in a solvent at a mass ratio of 100:5 to 100:0 to 100:20 to 100, the mixture was stirred at a temperature of 25 to 80° C. for 1 to 48 hours to prepare a homogeneous solution, and the obtained solution was poured onto a mold or substrate (e.g., glass plate, and stainless plate). Most of the solvent was removed at room temperature in an atmosphere of an inert gas to form an electrolyte membrane, the membrane was dried at a temperature of 25 to 100° C. for 2 to 48 hours, then transferred into a glove box filled with argon and dried for 2 to 48 hours to remove the residual solvent and water, thereby obtaining the solid electrolyte.

The additive ingredient is at least one selected from a polymer or a copolymer polymerized from a monomer represented by the following Formula (1), and a polymer represented by the following Formula (2):

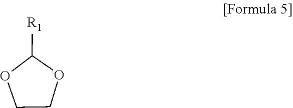

R₁ is an olefinic group having 2 to 6 carbon atoms.

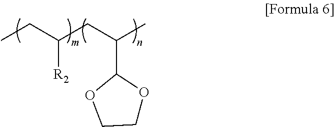

R₂ is a group having an ionic liquid structure such as —COOCH₃, imidazole, pyrrole, piperidine, and a quaternary ammonium.

Examples of the polymer matrix include, but are not particularly limited to, a copolymer of vinylidene fluoride and hexafluoropropylene, poly(vinylidene fluoride), and polytetrafluoroethylene.

Examples of the lithium salt include, but are not particularly limited to, lithium hexafluorophosphate (LiPF₆), lithium tetrafluoroborate (LiBF₄), lithium hexafluoroarsenate (LiAsF₆), lithium perchlorate (LiClO₄), and lithium bis(trifluoromethanesulfonyl)imide (LiTFSI), lithium bis(fluorosulfonyl)imide (LiFSI), and lithium trifluorosulfonimide (LiSO₃CF₃). Particularly LiTFSI/LiFSI is preferable.

Examples of the nitrile compound include, but are not particularly limited to, butanedinitrile, and 2,2-dimethylmalononitrile.

Examples of the solvent include, but are not particularly limited to, acetone, acetonitrile, 2-butanone, and dichloromethane.

### Preparation of Cell

A positive electrode sheet with lithium iron phosphate (LiFePO₄)/lithium cobalt oxide (LiCoO₂)/lithium nickel cobalt manganate (LiNiₓCo_{y}Mn_{1-x-y}O₂)/lithium nickel manganate (LiNi_{0.5}Mn_{1.5}O₄) as the positive electrode material, the obtained electrolyte membrane, and a negative electrode sheet containing lithium (Li) as the negative electrode material were laminated in order from the bottom to form a laminated body. Then, the laminated layers were pressed with a press machine to obtain a cell.

### Evaluation Test

Measurement of Molecular Weight

A molecular weight was measured at 40° C. by gel chromatography (GPC) using tetrahydrofuran (THF) as the mobile phase with reference to poly(methyl methacrylate) (PMMA) as the control.

Determination of Glass Transition Temperature

For determination of the glass transition temperature (T_{g}) of a sample, a differential scanning calorie meter (DSC) was used so that the temperature was raised at 10° C./min from room temperature to 200° C., kept there for 3 min, lowered at 10° C./min to −60° C., kept there for 3 min, and again raised to 200° C. at 10° C./min, and the T_{g} was determined using the curve measured in the second temperature rise phase.

Measurement of Discharge Capacity

The specific capacity of a cell was measured by measuring cell capacities at different charging currents and discharging currents under constant current conditions using a blue electric test system.

### EXAMPLE 1

A solid electrolyte with a copolymer of vinylidene fluoride and hexafluoropropylene (P(VDF-HFP))-poly(2-vinyl-1,3-dioxolane) (PDOL)-butanedinitrile (SN)-lithium bis(trifluoromethanesulfonyl)imide (LiTFSI) was prepared by a solution casting method. P(VDF-HFP), PDOL, SN, and LiTFSI at a mass ratio of 100:30:300:75 were stiffed at 50° C. for 12 hours to form a homogeneous solution. Thereafter, this solution was poured into a template made of polytetrafluoroethylene, most of the acetone was removed at room temperature in an Ar atmosphere, and then the electrolyte membrane was dried at 30° C. under vacuum for 48 hours and transferred into a glove box filled with argon for 24 hours, and dried to remove the residual solvent and water. The weight average molecular weight of the obtained polymer was 9021 g/mol, the glass transition temperature (T_{g}) was −14.4° C., and the melting point (Tₘ) of PDOL was 170.2° C. The ionic conductivity of LiTFSI added to 20% (wt) was 4.77×10⁻⁷ S/cm at 25° C., the initial specific discharge capacity of a Li/FePO₄ cell at 0.2 C, and 25° C. was 160 mAh/g, the specific discharge capacity at 0.2 C and 25° C. after 300 cycles was 144 mAh/g, and the capacity retention rate was 90%.

As shown in FIG. 1, a polymer in a viscous yellow solid state was obtained.

As can be seen from FIG. 6, the decomposition temperature (Td, 5% mass loss) of PDOL is 188.1° C., indicating excellent thermal stability.

### EXAMPLE 2

A solid electrolyte of P(VDF-HFP)-PDOL-SN-LiTFSI was prepared by a solution casting method. P(VDF-HFP), PDOL, SN, and LiTFSI at a mass ratio of 100:30:10:75 were stirred at 50° C. for 12 hours to form a homogenous solution. Thereafter, this solution was poured into a template made of polytetrafluoroethylene, most of the acetone was removed at room temperature in an Ar atmosphere, and then the electrolyte membrane was dried at 25° C. under vacuum for 48 hours, and transferred into a glove box filled with argon for 24 hours and dried to remove the residual solvent and water. The ionic conductivity of the obtained electrolyte was 1.8×10⁻⁴ S/cm, the initial specific discharge capacity of a Li/FePO₄ cell at 0.2 C and 25° C. was 150 mAh/g, the specific discharge capacity at 0.2 C and 25° C. after 100 cycles was 144 mAh/g, and the capacity retention rate was 90%.

### EXAMPLE 3

A solid electrolyte of a copolymer of poly(vinylidene fluoride) (PVDF)-2-vinyl-1,3-dioxolane and 1-vinyl-3-ethylbis(trifluoromethylsulfonyl)imidazole (P(DOL-IM₂TFSI))-LiTFSI was prepared by a solution casting method. PVDF, P(DOL-IM₂TFSI), SN, and LiTFSI were stirred at a mass ratio of 100:50:200:50 in an acetone solution at 50° C. for 24 hours to form a homogeneous solution. Next, this solution was poured into a template made of polytetrafluoroethylene, most of acetone was removed at room temperature in an Ar atmosphere, and then the electrolyte membrane was vacuum-dried at 25° C. for 48 hours and transferred into a glove box filled with argon for 24 hours to remove the residual solvent and water. The weight average molecular weight of the obtained polymer was 3281 g/mol, and the ionic conductivity at room temperature when LiTFSI was added to 20% (wt) was 2.2×10⁻⁸ S/cm, the ionic conductivity of the obtained electrolyte was 7.2×10⁻⁴ S/cm. The initial specific discharge capacity of a Li/LiNi_{0.6}Co_{0.2}Mn_{0.2}O₂ cell at 25° C. and 0.1 C was 178 mAh/g, the specific discharge capacity at 0.1 C and 25° C. after 200 cycles was 153 mAh/g, and the capacity retention rate was 86%.

### EXAMPLE 4

A solution of a solid electrolyte of PVDF-PDOL-dimethylmalononitrile-lithium bis(fluorosulfonyl)imide (LiFSI) was prepared by a casting method. PVDF, PDOL, dimethylmalononitrile, and LiFSI were stirred at a mass ratio of 100:50:250:75 in an acetone solution at 50° C. for 24 hours to form a homogeneous solution. Thereafter, this solution was poured into a template made of polytetrafluoroethylene, and most of the acetone was removed at room temperature in an Ar atmosphere. Thereafter the electrolyte membrane was vacuum-dried at 25° C. for 48 hours and transferred into a glove box filled with argon and dried for 24 hours to remove the residual solvent and water. The ionic conductivity of the obtained electrolyte was 4.5×10⁻⁴ S/cm, the initial specific discharge capacity of a Li/LiCoO₂ cell at 0.1 C, and 25° C. was 170 mAh/g, the specific discharge capacity at 0.1 C and 25° C. after 200 cycles was 136 mAh/g, and the capacity retention rate was 82%.

### EXAMPLE 5

A solid electrolyte of P(VDF-HFP)-PDOL-dimethylmalononitrile-LiFSI was prepared by a solution casting method. P(VDF-HFP), PDOL, dimethylmalononitrile, and LiFSI were stirred at a mass ratio of 100:100:100:100 in an acetone solution at 50° C. for 24 hours to form a homogeneous solution. Next, this solution was poured into a template made of polytetrafluoroethylene, most of the acetone was removed at room temperature in an Ar atmosphere, and then the electrolyte membrane was dried at 25° C. under vacuum for 48 hours, transferred into a glove box filled with argon and dried for 24 hours to remove the residual solvent and water. The ionic conductivity of the obtained electrolyte was 2×10⁻⁴ S/cm, the initial specific discharge capacity of a Li/LiNi_{0.6}Co_{0.2}Mn_{0.2}O₂ cell at 0.1 C, and 25° C. was 165 mAh/g, the specific discharge capacity at 0.1 C and 25° C. after 300 cycles was 136 mAh/g, and the capacity retention rate was 82%.

### EXAMPLE 6

A solid electrolyte of P(VDF-HFP)-P(DOL-IM₂TFSI)-SN-LiFSI was prepared by a solution casting method. P(VDF-HFP), P(DOL-IM₂TFSI), SN, and LiFSI were stirred at a mass ratio of 100:100:100:100 in an acetone solution at 50° C. for 24 hours to form a homogeneous solution. Next, this solution was poured into a template made of polytetrafluoroethylene, most of the acetone was removed at room temperature in an Ar atmosphere, and then the electrolyte membrane was dried at 25° C. under vacuum for 48 hours, transferred into a glove box filled with argon and dried for 24 hours to remove the residual solvent and water. The ionic conductivity of the obtained electrolyte was 8.3×10⁻⁴ S/cm, the initial specific discharge capacity of a Li/LiFePO₄ cell at 0.1 C, and 25° C. was 162 mAh/g, the specific discharge capacity at 0.1 C and 25° C. after 400 cycles was 120 mAh/g, and the capacity retention rate was 74%.

### Comparative Example 1

A solid electrolyte of P(VDF-HFP)-SN-LiTFSI was prepared by a solution casting method. P(VDF-HFP), SN, and LiTFSI were stiffed at a ratio of 100:300:75 at 50° C. for 12 hours to form a homogeneous solution. Thereafter, this solution was poured into a template made of polytetrafluoroethylene, most of the acetone was removed at room temperature in an Ar atmosphere. Then the electrolyte membrane was vacuum-dried at 25° C. for 48 hours, transferred into a glove box filled with argon, and dried for 24 hours to remove the residual solvent and water. The ionic conductivity of the obtained electrolyte was 2.0×10⁻³ S/cm, the initial specific discharge capacity at 0.2 C, and 25° C. was 160 mAh/g, the specific discharge capacity at 0.2 C and 25° C. after 300 cycles was 43.7 mAh/g, and the capacity retention rate was 27.3%.

The solid electrolyte according to the present application contains an ingredient stable to the lithium metal, can clearly improve the cycle performance of lithium metal batteries, and has unique innovativeness and potential application value.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A solid electrolyte for a lithium secondary battery, comprising a polymer matrix, a lithium salt, a nitrile compound, and an additive ingredient, wherein:
the additive ingredient is at least one selected from a polymer or a copolymer polymerized from a monomer represented by the following Formula (1), and a polymer represented by the following Formula (2): 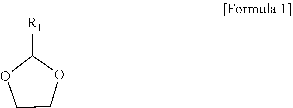
where R₁ is an olefin functional group having 2 to 6 carbon atoms; 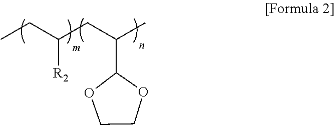
where R₂ is a functional group having an ionic liquid structure such as —COOCH₃, imidazole, pyrrole, piperidine, and a quaternary ammonium.

2. The solid electrolyte according to claim 1, comprising 5 to 200 parts by mass of the lithium salt, 10 to 500 parts by mass of the nitrile compound, and 20 to 100 parts by mass of the additive ingredient with respect to 100 parts by mass of the polymer matrix.

3. The solid electrolyte according to claim 1, wherein the weight average molecular weight of the additive ingredient is 1000 to 1000000 g/mol.

4. The solid electrolyte according to claim 1, wherein the additive ingredient is poly(2-vinyl-1,3-dioxolane), or a copolymer of 2-vinyl-1,3-dioxolane and 1-vinyl-3-ethyl-bis(trifluoromethylsulfonyl)imidazole.

5. A method for producing the solid electrolyte according to claim 1, comprising:
dissolving the polymer matrix, the lithium salt, the nitrile compound, and the additive ingredient in a solvent at a mass ratio of 100:5 to 200:10 to 500:20 to 100;
stirring the resulting mixture at a temperature of 25 to 80° C. for 1 to 48 hours to prepare a solution;
placing the resulting solution into a metal ware or a substrate;
removing most of the solvent in an atmosphere of an inert gas to form an electrolyte membrane;
vacuum-drying the electrolyte membrane at 25 to 100° C. for 2 to 48 hours; and
placing the electrolyte membrane in a glove box filled with argon and drying the electrolyte membrane for 2 to 48 hours to remove the solvent and water, thereby obtaining the solid electrolyte.

6. A lithium secondary battery, comprising the solid electrolyte according to claim 1.
